(19) United States
(12) Patent Application Publication
(10) Pub. No.: US 2025/0121280 A1
(43) Pub. Date: Apr. 17, 2025

(54) GAME PROGRAM FOR AERIAL IMAGE DISPLAY DEVICE

(71) Applicant: INTERMAN Corporation, Kagoshima-shi (JP)

(72) Inventors: Shigeki UETABIRA, Kagoshima-shi (JP); Yoshimasa SAITOH, Machida-shi (JP)

(73) Assignee: INTERMAN Corporation, Kagoshima-shi (JP)

(21) Appl. No.: 18/910,317

(22) Filed: Oct. 9, 2024

(30) Foreign Application Priority Data
Oct. 17, 2023 (JP) 2023-178779

(51) Int. Cl. A63F 13/25

(52) U.S. Cl. CPC A63F 13/25

(57) ABSTRACT

A game program capable of making maximum use of the characteristics of an aerial image display device including an aerial imaging system that projects an aerial image in the air, and a motion sensor that detects the motion of a hand of a user in the vicinity of the aerial image projected by the aerial imaging system. The game program controls the aerial imaging system to project an operation target in the air as an aerial image, and move the operation target projected by the aerial imaging system in response to the motion of the user's hand relative to the operation target detected by the motion sensor. The influence of gravity exerted on the operation target is reflected in the motion of the operation target.

### CROSS-REFERENCE TO RELATED APPLICATION

The present application claims priority under 35 U.S.C. § 119 to Japanese Patent Application No. P2023-178779, filed on Oct. 17, 2023 including description, claims, drawings, and abstract. The contents of this application are herein incorporated by reference in their entirety.

### FIELD

The present invention relates to a game program that can be executed using an aerial image display device capable of displaying aerial images.

### BACKGROUND

In recent years, technology that allows contactless interaction with aerial images formed using a special optical element has been attracting attention. Using this technology, it is possible to realize a completely contactless interface that is as easy to use as a conventional touch panel. A contactless interface minimizes the risk of infection from pathogens such as viruses and bacteria.

For example, as described in Japanese Patent Published Application No. 2018-147054, during surgery, a surgeon operates a contactless remote pointer displayed using aerial imaging technology, as it is a hygiene concern for the surgeon to touch pointing devices like a computer mouse. As an example of such special optical elements, there is an optical imaging device described in International Publication No. WO 2009/131128.

However, the current applications of aerial image display devices have mainly been limited to practical fields. The appearance of images floating in an empty space through aerial imaging technology alone has a significant impact and helps create a futuristic atmosphere. Additionally, displaying images as aerial projections can give a sense of three-dimensionality, as they appear to float above the surroundings.

Thereby, it is considered that this technology could be effectively utilized not only in practical fields but also in entertainment fields, such as games. In particular, applications in entertainment that take advantage of the unique characteristics of aerial image display devices are expected.

Therefore, it is an object of the present invention to provide a game program that takes advantage of the feature of an aerial image display device, where users can directly touch images floating in mid-air.

### SUMMARY

To achieve at least one of the above-mentioned objects, reflecting one aspect of the present invention, a game program is provided to be executed by a computer included in an aerial image display device comprising an aerial imaging system that projects an aerial image in the air, and a motion sensor that detects motion of a hand of a user in the vicinity of the aerial image projected by the aerial imaging system and transmits the detection results to the computer, wherein when executed the game program causes the computer to perform: a step of controlling the aerial imaging system to project an operation target in the air as an aerial image; and a step of moving the operation target projected by the aerial imaging system in response to the motion of the hand relative to the operation target detected by the motion sensor, and wherein in the step of moving the operation target, the influence of gravity exerted on the operation target is reflected in the motion of the operation target.

In accordance with a preferred embodiment of the present invention, a mass, a center of gravity and a moment of inertia are assigned to the operation target, wherein an interaction is defined according to interference between the aerial image of the operation target and the hand of the user, and wherein the influence of gravity and the interaction is reflected in the motion of the operation target based on the mass, center of gravity and moment of inertia.

Furthermore, in accordance with a preferred embodiment of the present invention, the aerial imaging system includes a display device that displays the operation target, and an optical plate whose incident surface faces the display device at an angle, wherein an image displayed on the display device is retro-transmitted through the optical plate to project the aerial image of the operation target.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing an aerial image display device 1 for executing an embodiment of a game program according to the present invention.

FIG. 2 is a cross-sectional view along line A-A of FIG. 1, showing the aerial image display device 1 in use.

FIG. 3 is a view for explaining the embodiment of the game program according to the present invention, showing the state where an egg T, displayed in mid-air as the object to be operated, is balanced on the hand.

FIG. 4 is a view for explaining the embodiment of the game program according to the present invention, showing the state where the egg T, displayed in mid-air as the object to be operated, is balanced on the hand while the wind is blowing to the left.

FIG. 5 is a view for explaining the embodiment of the game program according to the present invention, showing the state where the egg T, displayed in mid-air as the object to be operated, is balanced on the hand while the wind is blowing to the right.

FIG. 6 is a view for explaining the embodiment of the game program according to the present invention, showing the state where the score has exceeded a certain threshold, causing the egg T to crack and a character to come out from inside.

FIG. 7 is a view for explaining the embodiment of the game program according to the present invention, showing an example where the egg T exhibits unexpected movements.

FIG. 8 is a view for explaining the embodiment of the game program according to the present invention, showing the state where both hands are used to balance the egg T.

### DETAILED DESCRIPTION OF THE PREFERRED EMBODIMENT

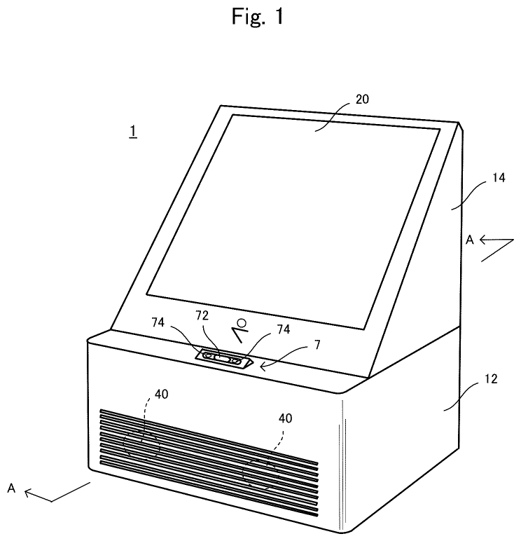

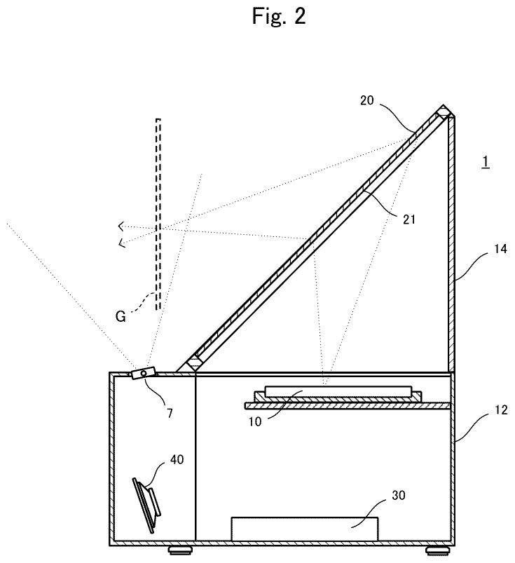

Hereinafter, an embodiment of the game program according to the present invention will be described with reference to the accompanying drawings. FIG. 1 is a perspective view showing an aerial image display device 1 for executing an embodiment of the game program. FIG. 2 is a cross-sectional view along line A-A of FIG. 1, showing the aerial image display device 1 in use.

As shown in FIGS. 1 and 2, the aerial image display device 1 includes a liquid crystal display 10 and an optical plate 20 as essential components. The aerial image display device 1 further includes an information processing device 30 that controls the liquid crystal display 10, a speaker 40, and the like. Here, the liquid crystal display 10, speaker 40, and information processing unit 30 are housed within the lower casing 12 and are connected to each other by signal lines (not shown in the figure).

The information processing device 30 is essentially a small computer and is composed of a CPU (Central Processing Unit), a ROM (Read Only Memory), a RAM (Random Access Memory), a storage device for storing various programs and data, input/output interfaces, and the like. As the input/output interface, for example, a USB port and a wireless LAN such as WIFI are implemented. The information processing unit 30 outputs video signals to the liquid crystal display 10, displaying aerial images. Furthermore, the information processing device 30 outputs an audio signal to the speaker 40 to generate voice guidance, sound effects, and the like. This information processing unit 30 can be a commercially available general-purpose small personal computer or a general-purpose tablet.

The liquid crystal display 10 is housed in a lower housing 12 that is rectangular in plan view and has an open top, and is supported substantially horizontally with the display screen facing upward. The optical plate 20 is fitted into the upper housing 14 so that the incident surface 21 faces downward and obliquely faces the display screen of the liquid crystal display 10. Here, the optical plate 20 and the liquid crystal display 10 are fixed at an angle of approximately 45 degrees.

The optical plate 20 can be a retro-transmitting optical imaging element (transmissive dihedral corner reflector array) as described in Japanese Patent Published Application No. 2011-175297. This optical imaging element is achieved by arranging numerous light-reflecting planes orthogonal to each other in a regular pitch. Alternatively, a structure such as the two-sided corner reflector with reflective surfaces formed on the sides of square holes, as described in Japanese Patent No. 4900618, can also be used.

The upper casing 14 of the aerial image display device 1 can be easily separated from the lower casing 12. When the upper housing 14 is separated, maintenance and adjustment inside the lower housing 12 can be easily performed, and the height during transportation can be reduced.

As shown in FIG. 2, the light from the display screen of the liquid crystal display 10 enters the optical plate 20, reflects twice within the optical plate 20, and exits from the opposite side. As a result, with the optical plate 20 as a symmetrical surface, an aerial image G is formed or projected as a real image in the space on the opposite side. Namely, an aerial imaging system is implemented with the optical plate 20 and the liquid crystal display 10. In this case, in order to realize a clearer aerial image G, it is preferable to prevent external light from mixing with the light from the liquid crystal display 10.

Additionally, a three-dimensional motion sensor 7, consisting of an infrared LED 72 and a pair of infrared cameras 74, is installed on the front upper side of the lower casing 12. This motion sensor 7 detects the motion of a hand of the user in three dimensions with high precision. The detection range of the motion sensor 7 is determined by the emission angle of the infrared LED 72 and the viewing angle of the infrared cameras 74. Such a motion sensor 7 can be a commercially available product, such as the Leap Motion Controller 2 sold by Ultraleap Ltd.

In particular, this three-dimensional motion sensor 7 is mounted so that its tilt angle can be adjusted. That is, the motion sensor 7 is housed in a mounting unit that can rotate within a certain angle range (here, ±20 degrees) around an axis perpendicular to the cross-sectional plane of FIG. 2. In this case, the center of the detection range of the motion sensor 7 is adjusted to be shifted toward the user from the center of the aerial image G. This adjustment maximizes the effective operation detection range.

Although not shown here, to make the aerial image visible at eye level, it is advisable to place the aerial image display device 1 on a table or other surface of an appropriate height. In particular, it is desirable to provide the table with a lifting device that allows the height of the table to be freely adjusted. An example of such a lifting device is an electric lifting device named “Mario N” sold by Yamato Metal Manufacturing Co., Ltd.

Typically, such aerial image display devices are used as input devices for administrative systems like reception systems. In other words, if a contactless interface screen is displayed as the aerial image G, the user can operate the interface using gestures, such as touching it with their fingers. The motion sensor 7, consisting of the infrared LED 72 and infrared cameras 74, detects these operations, and the corresponding operation signals are sent to the information processing unit 30, where predetermined processing is performed. The operation interface includes controls such as buttons, checkboxes, and drop-down menus. Thus, it is possible to achieve a fully contactless interface with the same ease of use as a conventional touch panel.

In the present invention, this aerial image display device is utilized for entertainment, particularly for games. Namely, the game program according to the present invention is stored in the storage device of the information processing apparatus 30 and executed by the information processing apparatus 30 such that a user can play the game program as described hereinbelow in detail. In this case, an object is displayed in the air as a target to be operated (operation target), and a mass, center of gravity, and moment of inertia are set for this object. The motion and rotation of the object are determined by a simulation based on its mass, center of gravity, and moment of inertia.

External forces acting on the object include interaction with the user's hand as well as gravity. This interaction is simulated by calculating the external force the object would receive from the user's hand if it physically existed.

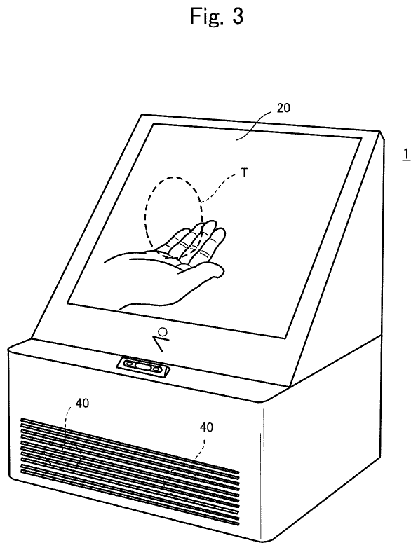

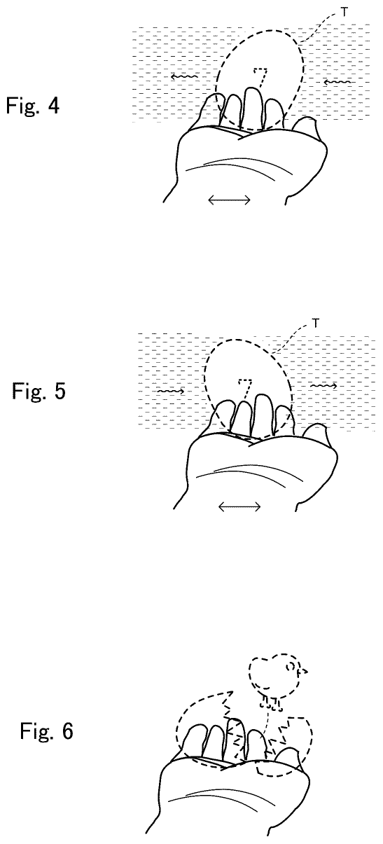

In the following embodiment, as shown in FIG. 3, a game is implemented in which the user balances an egg T displayed in the air on their hand. First, the aerial image of the egg T is displayed standing upright. The user gently touches the bottom of the displayed egg T with their hand. Then, the game starts such that the egg T begins to fall due to gravity, but if the user's hand is there, the egg will be supported. However, if left as is, the egg T on the hand will tilt and eventually fall off due to the influence of gravity, with the contact point with the hand as the pivot. If the egg falls and breaks, the game is over. Therefore, the user moves their hand left and right to balance the egg T vertically and prevent it from falling (see FIG. 4).

That is, the egg T's motion is simulated as an inverted pendulum, with the user's hand as the pivot point. However, since the aerial image in this embodiment is flat, the motion of the egg T is limited to within the display plane of the aerial image, and the rotation of the egg T is limited to a rotation axis perpendicular to the display plane of the aerial image. Thus, the degrees of freedom are three. This significantly reduces the computational load for the simulation. In this case, the user balances the egg by moving their hand left and right. The simulation is based on a well-known dynamics model of an inverted pendulum.

Specifically, the motion and rotation of the egg T are simulated based on the set mass, center of gravity, and moment of inertia, considering gravity and the interaction between the aerial image of the egg T and the user's hand. The interaction between the user's hand and the aerial image of the egg T is defined so that a force corresponding to the motion of the user's hand contacting the aerial image of the egg T is applied to the egg T at the contact position, taking into account the coefficient of friction between the user's hand and the egg T.

To increase the game's difficulty, wind can be simulated. For example, if the wind blows to the left, the user must balance the egg T by tilting it slightly to the right (see FIG. 4). Similarly, if the wind blows to the right, the user must balance the egg T by tilting it slightly to the left (see FIG. 5). When the wind stops, the user must balance the egg in the center. By adjusting the wind speed and its variability, various difficulty levels can be implemented. In order to visually indicate the direction of the wind, it is recommended to add a visual effect such as flowing mist (see FIGS. 4 and 5).

At higher difficulty levels, the wind speed is faster

and the wind direction changes randomly. The score increases depending on the difficulty level as set and the time the egg T is kept balanced. The score is displayed on the center of the egg T. In FIGS. 4 and 5, the score 7 is displayed. When the score reaches a certain level, the egg T breaks, and a character emerges from inside (see FIG. 6). This character is unique depending on the score and can be output on a card or with a three-dimensional printer.

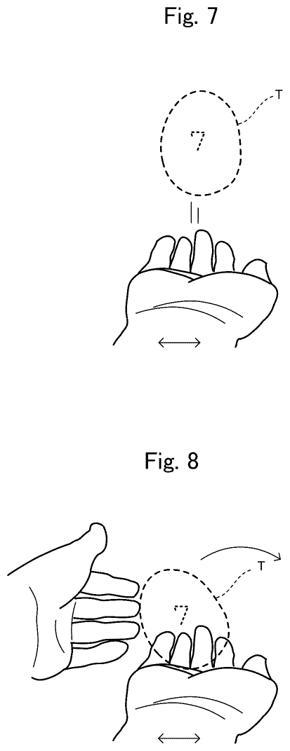

The difficulty can also be increased by making the egg T move unpredictably. For example, the egg T may suddenly jump (see FIG. 7). The user must catch it skillfully. If the user does not gently catch the egg, for instance, by lowering their hand slightly to match the egg's fall, the egg may break.

In the case of beginners who struggle to balance the egg, they may be allowed to assist with their left hand. For example, if the egg is about to tilt to the left, they can gently touch the left side of the egg T with their left hand to balance it (see FIG. 8).

According to the game program of the present invention, it is possible to make maximum use of the characteristics of an aerial image display device having an interface that has never been seen before.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

In this embodiment, the information processing device 30 is installed in the aerial image display device 1, but the present invention is not limited to this. For example, the information processing device 30 may be omitted, and an external video input terminal for inputting video signals to the liquid crystal display 10 and an external audio input terminal for inputting audio signals to the speakers may be provided in the aerial image display device 1, allowing necessary video and audio signals to be supplied from an external computer or similar device.

Furthermore, in the above embodiment, the operation detection unit consists of the infrared LED 72 and the infrared cameras 74, but the present invention is not limited to this. For example, the operation detection unit may be composed of a visible light LED and multiple visible light cameras.

Furthermore, in the above embodiment, an aerial image display device that uses a retro-transmitting optical imaging element is adopted. However, the present invention is not limited to this, and for example, an aerial image display device using a retro-reflective optical imaging element may also be adopted.

Moreover, in the above embodiment, a liquid crystal display is used, but the present invention is not limited to this. An organic EL display, an inorganic EL display, or electronic paper with a backlight, etc., may also be used.

What is claimed is:

1. A game program to be executed by a computer included in an aerial image display device, comprising: an aerial imaging system that projects an aerial image in the air, and a motion sensor that detects motion of a hand of a user in the vicinity of the aerial image projected by the aerial imaging system and transmits the detection results to the computer, wherein when executed the game program causes the computer to perform: a step of controlling the aerial imaging system to project an operation target in the air as an aerial image; and a step of moving the operation target projected by the aerial imaging system in response to the motion of the hand relative to the operation target detected by the motion sensor, and wherein in the step of moving the operation target, the influence of gravity exerted on the operation target is reflected in the motion of the operation target.

2. The game program according to claim 1, wherein a mass, a center of gravity and a moment of inertia are assigned to the operation target, wherein an interaction is defined according to interference between the aerial image of the operation target and the hand of the user, and wherein the influence of gravity and the interaction is reflected in the motion of the operation target based on the mass, center of gravity and moment of inertia.

3. The game program according to claim 2, wherein the aerial imaging system includes a display device that displays the operation target, and an optical plate whose incident surface faces the display device at an angle, and wherein an image displayed on the display device is retro-transmitted through the optical plate to project the aerial image of the operation target.
